(19) United States
(12) Patent Application Publication
(10) Pub. No.: US 2025/0042745 A1
(43) Pub. Date: Feb. 6, 2025

(54) NANOCARBON GENERATION APPARATUS AND NANOCARBON MANUFACTURING METHOD

(71) Applicant: NEC Corporation, Tokyo (JP)

(72) Inventor: Ryota YUGE, Tokyo (JP)

(73) Assignee: NEC Corporation, Tokyo (JP)

(21) Appl. No.: 18/782,416

(22) Filed: Jul. 24, 2024

(30) Foreign Application Priority Data
Aug. 4, 2023 (JP) 2023-127767
May 31, 2024 (JP) 2024-089463

(51) Int. Cl. C01B 32/15

(52) U.S. Cl. CPC C01B 32/15; C01P 2004/03; C01P 2004/64

(57) ABSTRACT

A nanocarbon generation apparatus includes a cylindrical target that contains carbon and a catalyst, and a laser irradiator configured to irradiate a peripheral surface of the cylindrical target with a laser beam at an incident angle of 50° or more and 80° or less, the incident angle being an angle between the laser beam and a normal line of the peripheral surface in a portion irradiated with the laser beam.

### CROSS-REFERENCE TO RELATED APPLICATION

The application is based on Japanese Patent Application No. 2023-127767 filed on Aug. 4, 2023 and Japanese Patent Application No. 2024-089463 filed on May 31, 2024, the content of which is incorporated herein by reference.

### BACKGROUND ART

The present disclosure relates to a nanocarbon generation apparatus and a nanocarbon manufacturing method.

It is known that a laser beam is used to generate carbon nanobrushes.

For example, PCT International Publication No. WO2018/155627 (hereinafter referred to as Patent Document 1) discloses a method of continuously irradiating the surface of a carbon target containing a metal catalyst such as iron with a laser beam and manufacturing carbon nanobrushes containing a carbon nanohorn aggregate.

### SUMMARY

The carbon nanobrushes disclosed in Patent Document 1 are obtained by irradiating a carbon target containing a catalyst with a laser, but it may be difficult to generate carbon nanobrushes depending on a laser irradiation angle.

An example object of the present disclosure is to provide a nanocarbon generation apparatus and a nanocarbon manufacturing method which solve the above-described problem.

A nanocarbon generation apparatus according to one example aspect of the present disclosure includes a cylindrical target that contains carbon and a catalyst, and a laser irradiator configured to irradiate a peripheral surface of the cylindrical target with a laser beam at an incident angle of 50° or more and 80° or less, the incident angle being an angle between the laser beam and a normal line of the peripheral surface in a portion irradiated with the laser beam.

A nanocarbon manufacturing method according to one example aspect of the present disclosure includes disposing a laser irradiator configured to emit a laser beam and a cylindrical target containing carbon and a catalyst, and irradiating a peripheral surface of the cylindrical target with the laser beam at an incident angle of 50° or more and 80° or less, the incident angle being an angle between the laser beam and a normal line of the peripheral surface in a portion irradiated with the laser beam.

According to a nanocarbon generation apparatus and a nanocarbon manufacturing method according to the present disclosure, carbon nanobrushes can be easily generated.

### BRIEF DESCRIPTION OF THE DRAWINGS

FIG. 1 is a perspective view of a nanocarbon generation apparatus in some example embodiments of the present disclosure.

FIG. 2 is a cross-sectional view of a nanocarbon generation apparatus in some example embodiments of the present disclosure.

FIG. 3 is a flowchart of a nanocarbon manufacturing method in some example embodiments of the present disclosure.

FIG. 4 is a cross-sectional view of a nanocarbon generation apparatus in some example embodiments of the present disclosure.

FIG. 5 is a cross-sectional view of a nanocarbon generation apparatus in some example embodiments of the present disclosure.

FIG. 6 is a flowchart of a nanocarbon manufacturing method in some example embodiments of the present disclosure.

FIG. 7 is a SEM image of nanocarbon generated at an incident angle of 30° in Example 1.

FIG. 8 is a SEM image of nanocarbon generated at an incident angle of 45° in Example 1.

FIG. 9 is a SEM image of nanocarbon generated at an incident angle of 60° in Example 1.

FIG. 10 is a SEM image of nanocarbon generated at an incident angle of 70° in Example 1.

FIG. 11 is a table showing a relationship between an evaporation amount and the graphite content ratio at each incident angle in Example 1.

FIG. 12 is a SEM image of nanocarbon generated under a helium atmosphere at an incident angle of 60° in Example 2.

FIG. 13 is a SEM image of nanocarbon generated under a nitrogen atmosphere at an incident angle of 60° in Example 2.

FIG. 14 is a SEM image of nanocarbon generated under an argon atmosphere at an incident angle of 60° in Example 2.

### EXAMPLE EMBODIMENT

Hereinafter, example embodiments according to the present disclosure will be described using the drawings. The drawings and specific configurations used in the example embodiments should not be used to analyze the disclosure. In all of the drawings, the same or corresponding configurations are given the same reference numerals, and repeated descriptions are omitted.

Some example embodiments of the present disclosure will be described below with reference to FIGS. 1 to 3.

### (Configuration of Nanocarbon Generation Apparatus)

As shown in FIG. 1, a nanocarbon generation apparatus 1 includes a cylindrical target 11, a laser irradiation unit 12 (a laser irradiator), and a chamber 14.

The nanocarbon generation apparatus 1 generates nanocarbon by irradiating the cylindrical target 11 with a laser L (a laser beam).

For example, the generated nanocarbon includes nano-sized carbon materials whose main component is carbon, such as a carbon nanotube (CNT), a carbon nanohorn (CNH), CNHs (carbon nanohorns) where carbon nanohorns are assembled, a carbon nanobrush (hereinafter referred to as CNB), amorphous carbon, fullerene, and graphene.

CNT is a fibrous material with a diameter of 0.7 to 1.5 nm, and the length of a single fiber is several 100 nm to several 10 μm. A cylindrical CNT made from a single graphene sheet is referred to as a single-walled carbon nanotube, and a carbon nanotube in which a plurality of CNTs with different diameters overlap each other coaxially to form a multi-layer is referred to as a multi-walled carbon nanotube. There are two types of CNTs: a semiconductor type that exhibits semiconductive properties and a metal type that exhibits metallic properties. The properties of the CNT change depending on how six-membered rings are arranged in the circumferential direction of the CNT.

A CNH is a cylindrical structure with a conical tip whose conical angle is approximately 19°, and has a diameter of 2 to 5 nm and a length of 40 to 50 nm.

CNHs are spherical aggregates formed by a plurality of single-layer CNHs formed from a single graphene sheet and gathered radially. The diameter of CNHs is approximately 50 to 100 nm.

Furthermore, CNHs are classified into a dahlia shape, a seed shape, a bud shape, a petal-dahlia shape, and the like depending on their shapes. These shapes can be appropriately selected by adjusting the atmospheric gas at the time of generating CNHs.

A CNB is a nanocarbon that has both high conductivity and high dispersibility, which are characteristics of CNT and CNHs. A CNB has a shape in which single-layer CNHs are radially aggregated and extended in the form of fibers. CNB has a diameter of approximately 30 to 60 nm and a length of several μm. For example, CNB may contain catalysts, graphene, or graphite within its structure.

CNB is obtained by irradiating the cylindrical target 11 to which a specific catalyst is added with a laser L. At this time, the cylindrical target 11 has a specific bulk density adjusted to have a certain amount of catalyst.

### (Configuration of Cylindrical Target)

The cylindrical target 11 contains carbon and a catalyst.

The bulk density of the cylindrical target 11 may be set as appropriate depending on the amount of the catalyst. For example, the bulk density of the cylindrical target 11 is 1.5 g/cm³ or less. For example, the bulk density of the cylindrical target 11 is 0.25 g/cm³ or more and 1.5 g/cm³ or less. For example, the bulk density of the cylindrical target 11 is 0.50 g/cm³ or more and 1.5 g/cm³ or less. For example, the bulk density of the cylindrical target 11 is 1.3 g/cm³ or more and 1.5 g/cm³ or less.

The cylindrical target 11 can generate CNB by having a range of a bulk density of 1.5 g/cm³ or less.

Within the range of the bulk density 1.5 g/cm³ or less, the lower the bulk density, the higher a CNB generation rate.

For example, the catalyst of the cylindrical target 11 may contain one of the group consisting of Fe, Ni, or Co. Since the catalyst contains one of the group consisting of Fe, Ni, and Co, CNB is generated from the cylindrical target 11 irradiated with the laser L. Further, the catalyst of the cylindrical target 11 may contain one type, two types, or three types among Fe, Ni, and Co. For example, since the CNB generation rate increases in the order of Fe>FeCo>Ni>Co=FeNi, Fe may be used as a catalyst.

For example, the amount of the catalyst with respect to the cylindrical target 11 is 0.3 at. % or more and 20 at. % or less. For example, the amount of the catalyst with respect to the cylindrical target 11 is 0.5 at. % or more and 3 at. % or less. For example, the amount of the catalyst with respect to the cylindrical target 11 is 1 at. % or more and 3 at. % or less.

The amount of the catalyst in the cylindrical target 11 is 3 at. % or less, and thus CNB can be generated.

In the case where the amount of the catalyst is within the range of 3 at. % or less, the higher the amount of the catalyst, the higher the CNB generation rate.

For example, the cylindrical target 11 has a diameter of 3 cm. The diameter of the cylindrical target 11 may be changed as appropriate depending on the power of the laser L.

For example, the cylindrical target 11 may be rotatable. For example, the cylindrical target 11 may be movable in the direction of a cylindrical axis O (direction D) of the cylindrical target 11.

In the manufacture of CNB, which will be described later, a laser ablation method of irradiating the cylindrical target 11 with a laser L is used. Since the cylindrical target 11 is rotatable, the cylindrical target 11 can always face a new surface with respect to an irradiation position P of the laser L. Thereby, the laser irradiation unit 12 can avoid irradiating the already irradiated surface with the laser L again and can always generate CNB on a new surface of the cylindrical target 11. For example, the irradiation position P of the laser L may move spirally with respect to the cylindrical target 11.

The rotational speed of the cylindrical target 11 is appropriately set based on a desired amount of nanocarbon to be generated.

For example, in a case where the cylindrical target 11 has a diameter of 3 cm, it rotates in one direction (direction ROT) around the cylindrical axis O at a rotational speed of 0.5 rpm or more and 4 rpm or less. Furthermore, in a case where the rotational speed is sufficiently higher than this range, it may be difficult to generate nanocarbon.

For example, the direction ROT may be a clockwise direction.

A feeding speed of the cylindrical target 11 is appropriately set depending on the bulk density of the cylindrical target 11, and the power and spot diameter of the emitted laser L.

For example, the cylindrical target 11 moves in the direction of the cylindrical axis O (direction D) at a feeding speed of 1 mm/min or more and 50 mm/min or less.

### (Configuration of Laser Irradiation Unit)

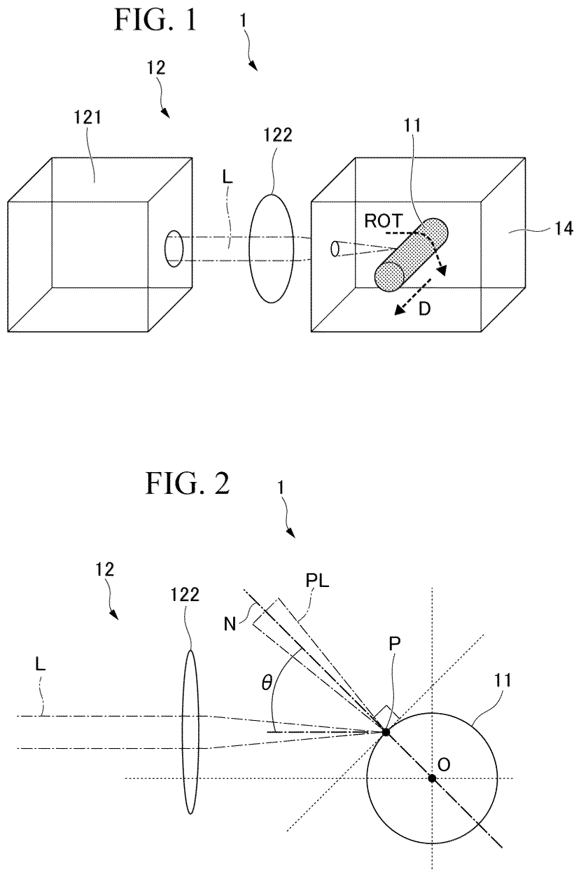

As shown in FIGS. 1 and 2, the laser irradiation unit 12 includes a laser source 121 and a lens 122. In FIG. 2, the chamber 14 and the laser source 121 are omitted to describe the laser L that is emitted to the cylindrical target 11.

The laser irradiation unit 12 emits the laser L. After the emission, heated carbon and catalyst evaporate at once from the irradiation position P of the cylindrical target 11, a plume PL is generated, and high-density carbon/catalyst droplets are formed. Among these droplets, CNH is formed in some of the droplets, and CNT is formed from the catalyst in other droplets. The formed CNHs grow into fibers using CNT as a template, and CNT and CNHs are partially bonded to each other by heat during a cooling process, thereby generating CNB. Nanocarbon generated by a laser ablation method is a mixture of CNB and CNHs (CNB/CNHs).

The laser source 121 emits a laser L.

For example, the laser L emitted by the laser source 121 includes a CO2 laser, an excimer laser, a YAG laser, a semiconductor laser, and the like. The laser L emitted by the laser source 121 may be any type of laser as long as it can heat the cylindrical target 11 to a high temperature.

The lens 122 condenses the laser L, and the laser Lis emitted toward the cylindrical target 11 from an irradiation window of the chamber 14.

The lens 122 is a condenser lens. For example, the lens 122 is a ZnSe lens.

An operator sets a laser output using the laser source 121 and appropriately sets a spot diameter using the lens 122 so that a desired amount of nanocarbon is generated.

For example, the operator sets the laser output to 1.0 kw or more and 10 kw or less for the cylindrical target 11. For example, the operator sets the laser output to 2.0 kw or more and 5.0 kw or less for the cylindrical target 11. In a case where the laser output is lower than this range, an evaporation amount of the cylindrical target 11 will be small, making it difficult to generate sufficient CNB.

For example, the operator sets the spot diameter for the cylindrical target 11 so that an irradiation area is in the range of 0.002 cm² to 0.2 cm². That is, the operator sets the spot diameter to 0.5 mm or more and 5 mm or less.

The laser irradiation unit 12 irradiates the peripheral surface of the cylindrical target 11 with a laser L at an incident angle of 50° or more and 80° or less. At this time, the incident angle is an angle θ formed by the laser L and a normal line N of the peripheral surface in a portion irradiated with the laser.

Since the plume PL is formed on the normal line N of the peripheral surface in the portion irradiated with the laser, it is desirable that the operator adjust the irradiation direction of the laser L so as not to disturb the formed plume PL and so as to make it easier to collect the evaporated nanocarbon. For example, the operator adjusts the irradiation direction of the laser L so that the laser L forms an angle θ with the normal line N.

The laser irradiation unit 12 emits the laser L at an incident angle of 50° or more and 80° or less, and thus it is possible to increase a CNB generation rate compared to emitting the laser L at other incident angles and manufacture high-purity CNB/CNHs with suppressed generation of impurities such as graphite that do not contribute to electrical characteristics of CNB/CNHs.

For example, the laser irradiation unit 12 may irradiate the peripheral surface of the cylindrical target 11 with a laser at an incident angle of 60° or more and 70° or less. The laser irradiation unit 12 can generate higher-purity and more CNB from the cylindrical target 11.

The laser irradiation unit 12 emits a laser L in a plane perpendicular to the cylindrical axis O of the cylindrical target 11. Thereby, an incident angle that is set in a plane perpendicular to the cylindrical axis O can be converted into the actual incident angle with respect to the peripheral surface of the cylindrical target 11, and thus the operator can easily set a desired incident angle for the cylindrical target 11. In addition, since the energy density of the laser L on the peripheral surface of the cylindrical target 11 can be increased, a necessary energy density can be secured.

For example, the laser L emitted by the laser irradiation unit 12 is expected to be emitted from a position above or below the cylindrical axis O in a plane perpendicular to the cylindrical axis O.

For example, in the present example embodiment, the laser L is emitted from above the cylindrical axis O (FIG. 2) in a plane perpendicular to the cylindrical axis O.

### (Configuration of Chamber)

The chamber 14 has an irradiation window through which the laser L passes.

The inside of the chamber 14 is in a vacuum state or filled with an inert gas.

For example, the inside of the chamber 14 is filled with nitrogen, argon, or the like.

The pressure within the chamber 14 is appropriately set depending on a desired amount of nanocarbon to be generated.

For example, the pressure within the chamber 14 is maintained at 760 Torr in a case where the chamber 14 is filled with an inert gas.

The temperature inside the chamber 14 is set to an arbitrary temperature.

For example, the temperature inside the chamber 14 is 25° C.

For example, the inside of the chamber 14 is maintained at a constant pressure and temperature during irradiation with the laser L. For example, the chamber 14 has an exhaust port (not shown) and an inert gas inlet (not shown). During irradiation with the laser L, an inert gas is supplied from the inert gas inlet to the chamber 14 at a rate of 10 L/min, and the same amount of gas in the chamber is exhausted from the exhaust port.

For example, a flow rate of the inert gas supplied into the chamber 14 and a flow rate of the gas exhausted from the chamber 14 are appropriately set depending on an evaporation amount of the cylindrical target 11.

For example, the chamber 14 may have a separate collection port, and the operator may collect CNB/CNHs through the collection port.

### (Nanocarbon Manufacturing Method)

A nanocarbon manufacturing method in the present example embodiment will be described.

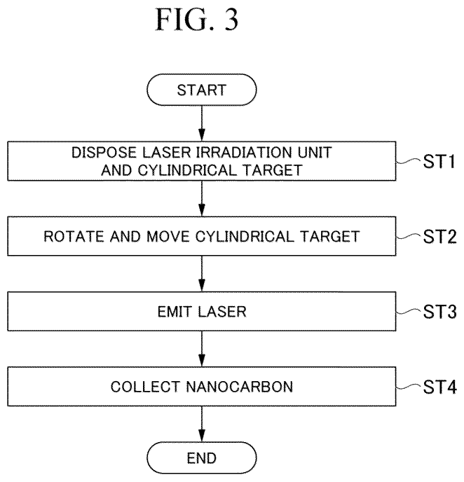

The nanocarbon manufacturing method in the present example embodiment is performed in accordance with a flow shown in FIG. 3

First, an operator disposes the laser irradiation unit 12 capable of emitting a laser L and the cylindrical target 11 containing carbon and a catalyst (ST1).

For example, the operator may dispose the laser irradiation unit 12 so that the laser irradiation unit 12 emits the laser L in a plane perpendicular to the cylindrical axis O of the cylindrical target 11. Thereby, it is easy for the operator to grasp a positional relationship of the laser L with respect to the cylindrical target 11 and change a relative position.

Further, in the case where the operator disposes the cylindrical target 11 the operator may dispose the cylindrical target with the cylindrical axis O shifted from the laser L for ST3 which will be described later. Thereby, the irradiation position P of the laser L on the cylindrical target 11 changes, and an incident angle also changes.

For example, the catalyst of the cylindrical target 11 may contain one of the group consisting of Fe, Ni, or Co. Since the catalyst contains one of the group consisting of Fe, Ni, and Co, CNB is generated from the cylindrical target 11 irradiated with the laser L. Further, the catalyst of the cylindrical target 11 may contain one type, two types, or three types among Fe, Ni, and Co. For example, since a CNB generation rate increases in the order of Fe>FeCo>Ni>Co=FeNi, the operator may use Fe as a catalyst.

For example, a bulk density of the cylindrical target 11 may be 1.5 g/cm³ or less. The operator can generate CNB by using the cylindrical target 11 having a bulk density in the range of 1.5 g/cm³ or less. In the case where the bulk density is within the range of 1.5 g/cm³ or less, the higher the bulk density, the higher the CNB generation rate.

For example, the amount of the catalyst in the cylindrical target 11 may be 0.5 at. % or more and 3 at. % or less. The operator uses the cylindrical target 11 whose amount of the catalyst is 3 at. % or less, and thus CNB can be generated. In the case where the amount of the catalyst is within the range of 3 at. % or less, the higher the amount of the catalyst, the higher the CNB generation rate.

Next, in order to spirally scan the irradiation position P of the laser L on the peripheral surface of the cylindrical target 11, the operator rotates the cylindrical target 11 in one direction (direction ROT) around the cylindrical axis O and moves the cylindrical target 11 in the direction of the cylindrical axis O (direction D) (ST2).

Thereby, the cylindrical target 11 can always face a new surface with respect to the irradiation position P for the cylindrical target 11. Thereby, the laser irradiation unit 12 can avoid irradiating the already irradiated surface with the laser L again and can always generate CNB on a new surface of the cylindrical target 11.

Next, the operator fills the chamber with an inert gas and controls the pressure to approximately 760 Torr. In a case where the pressure is 500 to 1000 Torr, it is easy for the operator to control the pressure. By changing an atmospheric gas (inert gas) by the operator, the proportion of CNB to be generated changes. The larger the atomic weight, the more CNB is generated. In particular, in a case where argon or krypton is used as the atmospheric gas, the proportion of CNB to be generated increases. Although CNB can also be generated from neon, the gas is expensive, resulting a problem in a reduction in costs.

Next, the operator irradiates the peripheral surface of the cylindrical target 11 with the laser L at an incident angle of 50° or more and 80° or less (ST3). At this time, the incident angle is an angle θ between the laser L and a normal line N of the peripheral surface in a portion irradiated with the laser L.

After the irradiation, the heated carbon and catalyst evaporate at once from the irradiation position P of the cylindrical target 11, a plume PL is generated, and high-density carbon/catalyst droplets are formed. Among these droplets, CNH is formed in some of the droplets, and CNT is formed from the catalyst in other droplets. The formed CNHs grow into fibers using CNT as a template, and CNT and CNHs are partially bonded to each other by heat during a cooling process, thereby generating CNB. Nanocarbon generated by a laser ablation method is a mixture of CNB and CNHs (CNB/CNHs).

Since the plume PL is formed on the normal line N of the peripheral surface in the portion irradiated with the laser, it is desirable that the operator adjust the irradiation direction of the laser L so as not to disturb the formed plume PL and so as to make it easier to collect the evaporated nanocarbon. For example, the operator adjusts the irradiation direction of the laser L so that the laser L forms an angle θ with the normal line N.

By emitting the laser L at an incident angle of 50° or more and 80° or less, and thus the operator can increase a CNB generation rate compared to emitting the laser L at other incident angles and create high-purity CNB/CNHs with suppressed generation of impurities such as graphite that do not contribute to electrical characteristics of CNB/CNHs.

For example, the laser irradiation unit 12 may irradiate the peripheral surface of the cylindrical target 11 with the laser L at an incident angle of 60° or more and 70° or less. The operator can generate higher-purity and more CNB from the cylindrical target 11.

For example, the operator may change the incident angle by disposing the cylindrical target 11 with the shifted cylindrical axis O in ST1. By changing the incident angle, the operator can generate higher-purity and more CNB from the cylindrical target 11.

Next, the operator collects nanocarbon (ST4).

The operator collects the CNB/CNHs formed by an evaporation from the irradiation position P and a generation of a plume PL.

For example, an operator collects CNB/CNHs attached to the wall surface of the chamber 14.

For example, the operator may collect CNB/CNHs from a collection port provided separately in the chamber 14.

For example, at the time of collecting nanocarbon, the operator may remove a metal catalyst contained in CNB/CNHs. The metal catalyst is dissolved in nitric acid, sulfuric acid, and hydrochloric acid and removed.

For example, at the time of collecting nanocarbon, the operator may open holes in CNB by oxidation treatment.

For example, at the time of collecting nanocarbon, the operator may perform heat treatment on CNB under an inert atmosphere in order to improve crystallinity. Examples of “under an inert atmosphere” include under an atmosphere of an inert gas, nitrogen, or hydrogen, or in vacuum.

Here, high-purity CNB/CNHs containing few impurities such as graphite is obtained (completed).

### (Actions and Effects)

According to the nanocarbon generation apparatus 1 of the present example embodiment, by emitting a laser L at an incident angle of 50° or more and 80° or less, heat is prevented from being trapped in the cylindrical target 11, and the cylindrical target 11 can be heated with less laser energy loss than at other incident angles. Thereby, it is possible to manufacture high-purity CNB/CNHs containing few impurities such as graphite and increase the proportion of CNB in nanocarbon generated from the cylindrical target 11.

Thus, the nanocarbon generation apparatus 1 according to the present disclosure easily generates carbon nanobrushes.

For example, in a laser ablation method, a shock wave is generated on the surface of the cylindrical target 11 by irradiating the cylindrical target 11 with the laser L. Graphite contained in the cylindrical target 11 is scattered due to the shock wave and may be contained in the generated CNB/CNHs.

In a case where a large amount of graphite is contained, a graphite separation step is required for the generated CNB/CNHs.

On the contrary, according to the nanocarbon generation apparatus 1 of the present example embodiment, the generated CNB/CNHs contains less graphite, and thus it is also useful in terms of workability as it is not necessary to perform a subsequent graphite separation step.

As a comparative example, a case where an operator generates CNB by irradiating a carbon target containing a catalyst with a laser without specifying an incident angle. Also in this comparative example, CNB, CNHs, and the like are generated in a process of cooling evaporated carbon, but a main product of CNB/CNHs generated by a laser ablation method is often CNHs, and it is necessary to develop a method of generating a large amount of CNB.

On the contrary, in one example of the present example embodiments, by emitting a laser L at an incident angle of 50° or more and 80° or less, heat is prevented from being trapped in the cylindrical target 11, and the cylindrical target 11 can be heated with less laser energy loss than at other incident angles. Thereby, it is possible to manufacture high-purity CNB/CNHs containing few impurities such as graphite and increase the proportion of CNB in nanocarbon generated from the cylindrical target 11.

For this reason, it is easy to generate carbon nanobrushes.

Further, similarly to a CNH spherical aggregate (CNHs), CNB has excellent high dispersibility and high adsorptivity, and also has high electrical conductivity.

Thus, in high-purity CNB/CNHs with few impurities as in the present example embodiment, a further improvement in properties can be expected by application to conductive materials of lithium ion batteries, high capacity capacitor electrodes, polymer actuator electrodes, sensor electrodes, catalyst supports, and the like.

### Modification Example

In the above-described example embodiments, the direction ROT is a clockwise direction, and the laser L is emitted from above the cylindrical axis O in a plane perpendicular to the cylindrical axis O.

As a modification example, the direction ROT may be a clockwise direction, and the laser L may be emitted from below the cylindrical axis O in a plane perpendicular to the cylindrical axis O.

In the above-described example embodiments, the direction ROT is a clockwise direction, and the laser Lis emitted from above the cylindrical axis O in a plane perpendicular to the cylindrical axis O.

As a modification example, the direction ROT may be a counterclockwise direction, and the laser L may be emitted from below the cylindrical axis O in a plane perpendicular to the cylindrical axis O.

In the above-described example embodiments, the direction ROT is a clockwise direction, and the laser Lis emitted from above the cylindrical axis O in a plane perpendicular to the cylindrical axis O.

For example, as a modification example, the direction ROT may be a counterclockwise direction, and the laser L may be emitted from above the cylindrical axis O in a plane perpendicular to the cylindrical axis O.

In the above-described example embodiments, by emitting the laser L at the irradiation position P where an incident angle is 50° or more and 80° or less, heat is prevented from being trapped in the cylindrical target 11, and cylindrical target 11 can be heated with less laser energy loss than at other incident angles. Thereby, the nanocarbon generation apparatus 1 capable of producing high-purity CNB/CNHs containing few impurities such as graphite and increasing the proportion of CNB in nanocarbon generated from the cylindrical target 11 is disclosed.

On the other hand, a nanocarbon generation apparatus 5 according to the present example embodiments further includes a moving mechanism (an adjuster) capable of adjusting an incident angle. The nanocarbon generation apparatus 5 according to the present example embodiments can adjust an incident angle by shifting the cylindrical axis O of the cylindrical target 11. It is also noted that the nanocarbon generation apparatus 5 according to the present example embodiments makes it easier to adjust an incident angle than adjusting an incident angle by changing the position of the laser irradiation unit 12.

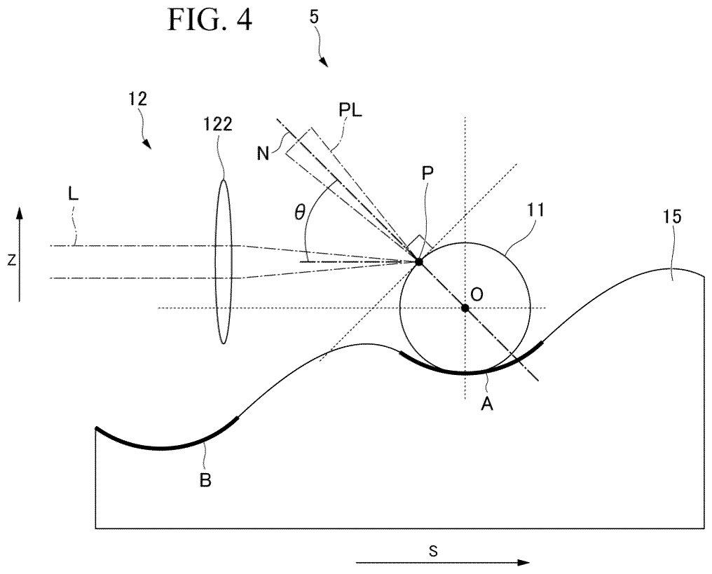

Hereinafter, the nanocarbon generation apparatus according to the present disclosure will be described as some example embodiments of the present disclosure with reference to FIG. 4.

Components in common with those in the above-described example embodiments are given the same reference numerals, and detailed description thereof will be omitted.

### (Configuration)

As shown in FIG. 4, the nanocarbon generation apparatus 5 includes a cylindrical target 11, a laser irradiation unit 12, a chamber 14, and a cam 15.

The cam 15 has a surface that fits to a part of the peripheral surface of the cylindrical target 11 so that the cylindrical target 11 can be held.

The cylindrical target 11 is fitted to the cam 15.

The cam 15 is a moving mechanism that shifts a cylindrical axis O of the cylindrical target 11 with respect to a laser L.

A fitting position of the cylindrical target 11 fitted to the cam 15 moves by the movement of the cam 15. Thereby, an irradiation position P of the laser L changes, and an incident angle also changes in accordance with the irradiation position P.

For example, a fitting position A of the cylindrical target 11 moves to a fitting position B by moving the cam 15 in a direction S. Thereby, the irradiation position P of the laser L moves in a direction Z, and an incident angle also changes in accordance with the irradiation position P.

For example, the cam 15 may have a roller or a runner that rolls in association with the rotation of the cylindrical target 11 on a surface that fits to a part of the peripheral surface of the cylindrical target 11.

For example, instead of the cam 15, the moving mechanism for shifting the cylindrical axis O of the cylindrical target 11 may be a hand chuck that can chuck the end of the cylindrical target 11.

By separately controlling the position of the hand chuck, the cylindrical axis O of the cylindrical target 11 can be shifted.

For example, by rotating the hand chuck in one direction (direction ROT) around the cylindrical axis O of the cylindrical target 11 and moving it in the direction of the cylindrical axis O (direction D) of the cylindrical target 11, the nanocarbon generation apparatus 5 can cause the irradiation position P of the laser L to spirally move with respect to the cylindrical target 11.

### (Actions and Effects)

According to the nanocarbon generation apparatus 5 of the present example embodiments, by emitting a laser L at an incident angle of 50° or more and 80° or less, heat is prevented from being trapped in the cylindrical target 11, and the cylindrical target 11 can be heated with less laser energy loss than at other incident angles. Thereby, it is possible to manufacture high-purity CNB/CNHs containing few impurities such as graphite and increase the proportion of CNB in nanocarbon generated from the cylindrical target 11.

In addition, by shifting the cylindrical axis O of the cylindrical target 11, it is possible to appropriately change an incident angle and determine the incident angle that makes it possible to manufacture high-purity CNB/CNHs and increase the proportion of CNB in nanocarbon.

Thus, the nanocarbon generation apparatus 1 according to the present disclosure easily generates carbon nanobrushes.

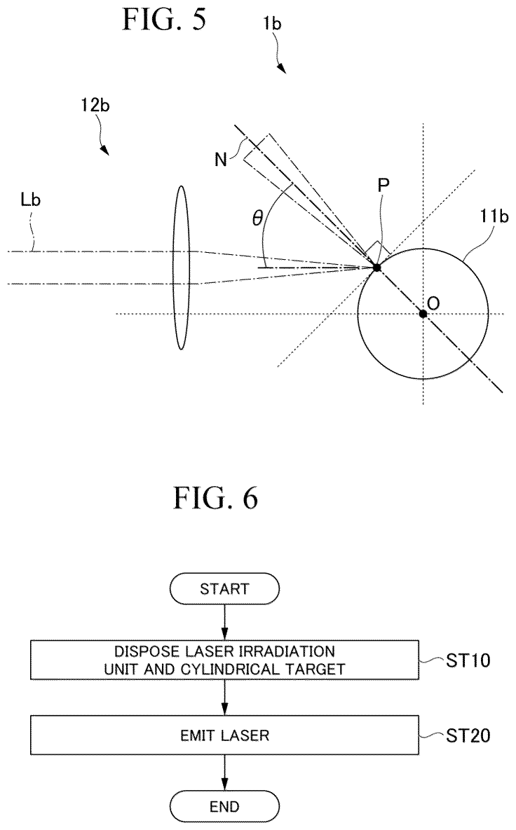

Hereinafter, some example embodiments of the nanocarbon generation apparatus according to the present disclosure will be described with reference to FIG. 5.

### (Configuration)

A nanocarbon generation apparatus 1b includes a cylindrical target 11b containing carbon and a catalyst, and a laser irradiation unit 12b that irradiates the peripheral surface of the cylindrical target 11b with a laser Lb at an incident angle of 50° or more and 80° or less, and the incident angle is an angle θ between a laser L and a normal line N of the peripheral surface in a portion irradiated with the laser Lb.

### (Actions and Effects)

According to the nanocarbon generation apparatus 1b of the present example embodiments, by emitting the laser Lb at an incident angle of 50° or more and 80° or less, heat is prevented from being trapped in the cylindrical target 11b, and the cylindrical target 11b can be heated with less laser energy loss than at other incident angles. Thereby, it is possible to manufacture high-purity CNB/CNHs containing few impurities such as graphite and increase the proportion of CNB in nanocarbon generated from the cylindrical target 11b.

Thus, the nanocarbon generation apparatus 1b according to the present disclosure easily generates carbon nanobrushes.

Hereinafter, some example embodiments of a nanocarbon manufacturing method according to the present disclosure will be described with reference to FIG. 6.

The nanocarbon manufacturing method in the present example embodiments is performed in accordance with a flow shown in FIG. 6.

The nanocarbon manufacturing method includes a step (ST10) of disposing a laser irradiation unit capable of emitting a laser and a cylindrical target containing carbon and a catalyst and a step (ST20) of irradiating the peripheral surface of the cylindrical target with a laser at an incident angle of 50° or more and 80° or less, and the incident angle is an angle formed by the normal direction of the peripheral surface in a portion irradiated with the laser and a laser irradiation direction.

### (Actions and Effects)

According to the nanocarbon manufacturing method of the present example embodiments, by emitting a laser at an incident angle of 50° or more and 80° or less, heat is prevented from being trapped in the cylindrical target, and the cylindrical target can be heated with less laser energy loss than at other incident angles. Thereby, it is possible to manufacture high-purity CNB/CNHs containing few impurities such as graphite and increase the proportion of CNB in nanocarbon generated from the cylindrical target.

Thus, the nanocarbon manufacturing method according to the present disclosure makes it easy to generate carbon nanobrushes.

### EXAMPLES

Hereinafter, effects of the present disclosure will be described more specifically using examples. Conditions in the examples are examples of conditions adopted to confirm the feasibility and effects of the present disclosure, and the present disclosure is not limited to the examples of conditions. The present disclosure may adopt various conditions as long as the objectives of the present disclosure are achieved without departing from the gist of the present disclosure.

### Example 1

The conditions of the nanocarbon generation apparatus 1 for generating CNB were as follows.

The cylindrical target 11 had a diameter of 3 cm.

The cylindrical target 11 contained a catalyst Fe and was created with a bulk density of 1.5 g/cm³. The amount of the catalyst of the cylindrical target 11 was 3 at. %.

The rotational speed of the cylindrical target 11 was 2 rpm.

The cylindrical target 11 rotated clockwise around the cylindrical axis O.

The feeding speed of the cylindrical target 11 was set appropriately.

The laser L emitted by the laser irradiation unit 12 was emitted from above the cylindrical axis O in a plane perpendicular to the cylindrical axis O.

The laser L emitted by the laser source 121 of the laser irradiation unit 12 was a CO2 laser.

The lens 122 was a ZnSe lens.

A laser output of the laser irradiation unit 12 and a spot diameter were set appropriately.

An incident angle, which is an angle θ formed by the laser L and the normal line N of the peripheral surface in the portion irradiated with the laser, was set to four values: 30°, 45°, 60°, and 70°.

The inside of the chamber 14 was filled with nitrogen.

The pressure inside the chamber 14 was maintained at 760 Torr.

The temperature inside the chamber 14 was 25° C.

During the irradiation with the laser L, the chamber 14 was supplied with nitrogen at a rate of 10 L/min from a nitrogen inlet, and the same amount of nitrogen in the chamber was exhausted from an exhaust port. Thereby, the inside of the chamber 14 was maintained at a constant pressure and temperature during the irradiation with the laser L.

After CNB/CNHs attached to the wall surface of the chamber 14 was collected, CNB/CNHs was uniformly dispersed in ethanol, and then one obtained by evaporating the ethanol was treated using thermal gravimetric analysis (TGA).

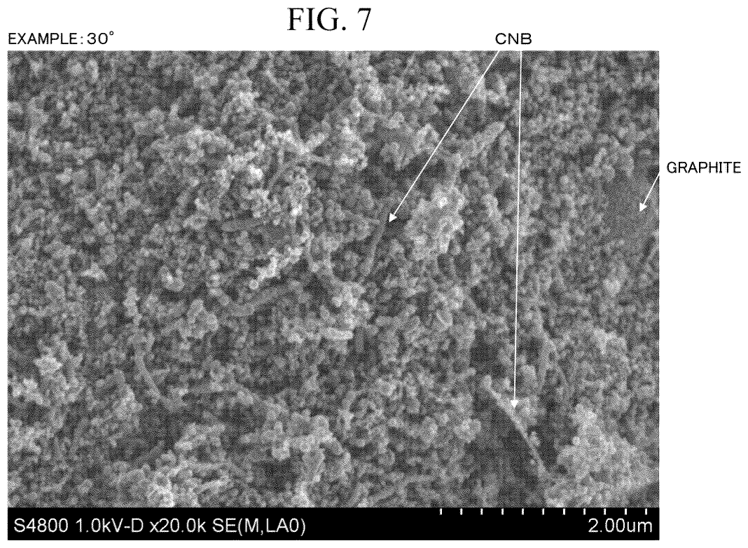

After the ethanol was evaporated, CNB/CNHs was observed using a scanning electron microscope (SEM). The results are shown in FIGS. 7 to 10.

FIG. 7 is a SEM image of CNB/CNHs generated at an incident angle of 30°.

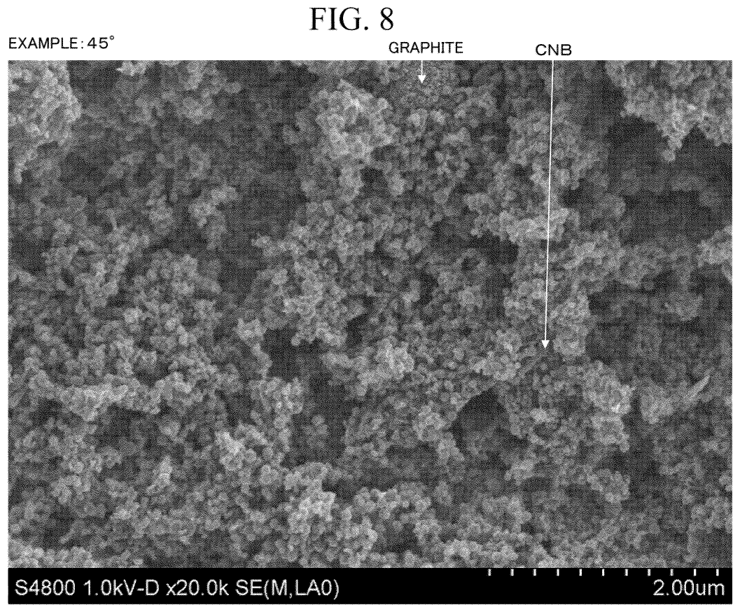

FIG. 8 is a SEM image of CNB/CNHs generated at an incident angle of 45°.

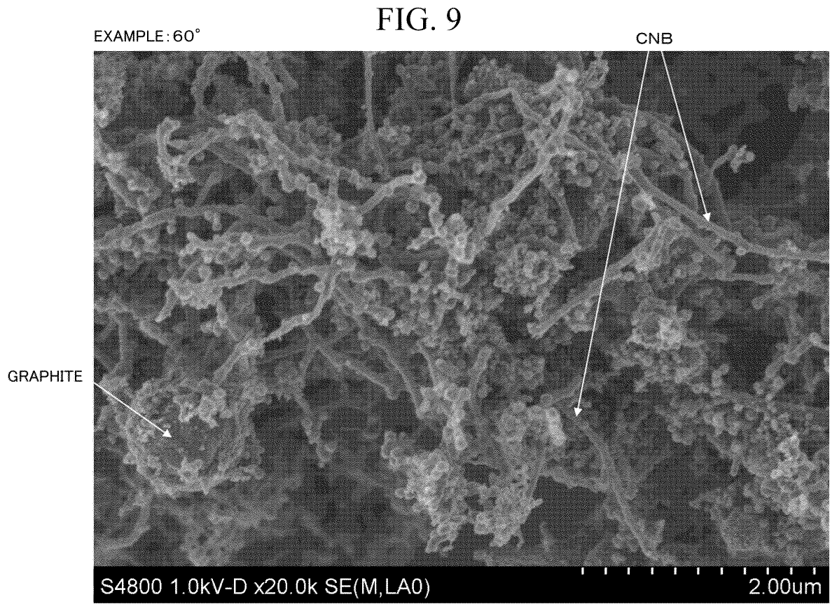

FIG. 9 is a SEM image of CNB/CNHs generated at an incident angle of 60°.

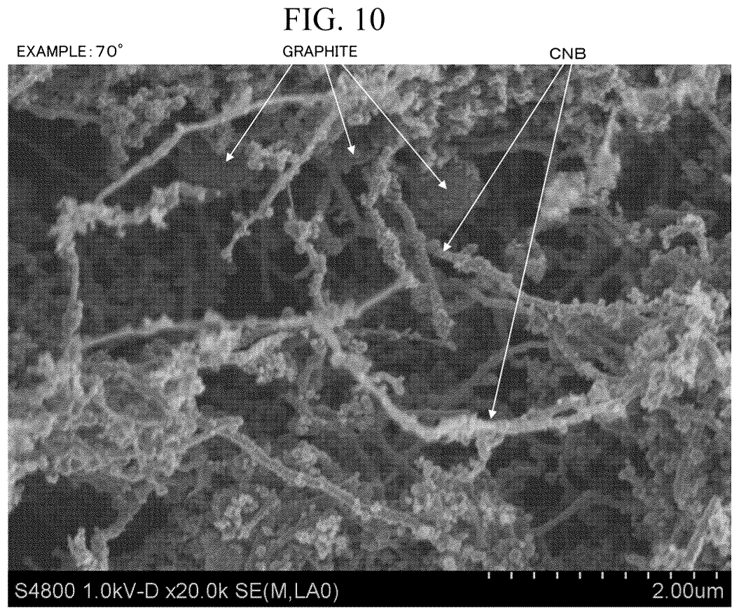

FIG. 10 is a SEM image of CNB/CNHs generated at an incident angle of 70°.

At each incident angle, many CNB and granular CNHs attached to the surface of the CNB were confirmed.

It was confirmed that, as the incident angle increased, a CNB generation rate was improved in the SEM image.

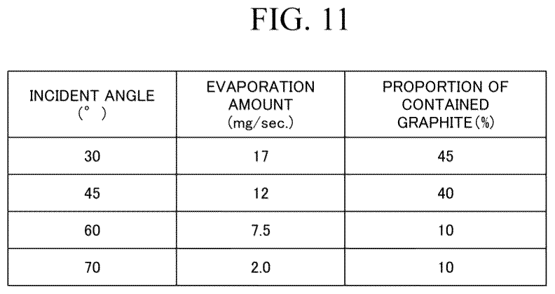

In TGA, the proportion of impurities contained in CNB/CNHs is measured by a temperature during combustion and thermal decomposition. Amorphous carbon and fullerene with low crystallinity are combusted at a first temperature, and CNH and CNT are combusted at a second temperature which is a higher temperature. In a case where the temperature is further increased, highly crystalline graphite will remain finally. The proportion of graphite contained in CNB/CNHs is summarized in a table of FIG. 11.

FIG. 11 is a table showing a relationship between an evaporation amount and the amount of impurities at each incident angle. It is confirmed that, as the incident angle increases, the evaporation amount of the cylindrical target 11 decreases, but the proportion of graphite contained in CNB/CNHs also decreases.

Thus, the following can be said from the present example.

In the case where an incident angle is 60° or more and 70° or less, high-purity CNB/CNHs containing few impurities such as graphite can be manufactured, and the proportion of CNB in nanocarbon generated from the cylindrical target 11 can be increased.

As a reason, it is considered that, by emitting the laser L at an incident angle of 50° or more and 80° or less, heat is prevented from being trapped in the cylindrical target 11, and the cylindrical target 11 can be heated with less laser energy loss than at other incident angles.

Furthermore, the present example also shows that there is a possibility that it is not necessary to perform a subsequent graphite separation step because the amount of graphite contained in generated CNB/CNHs is small.

### Example 2

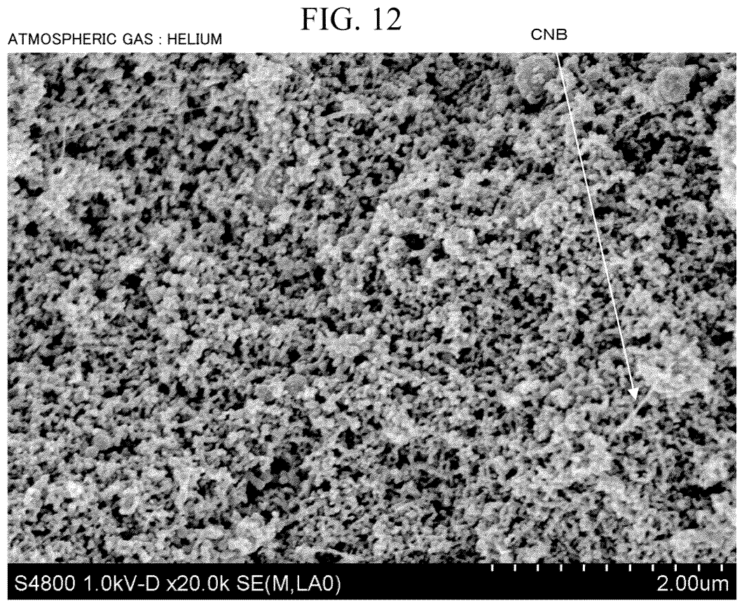

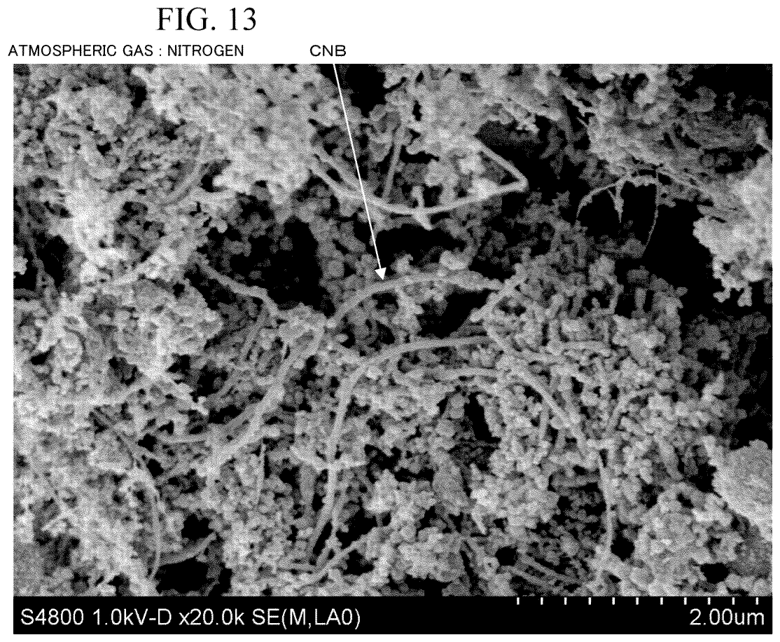

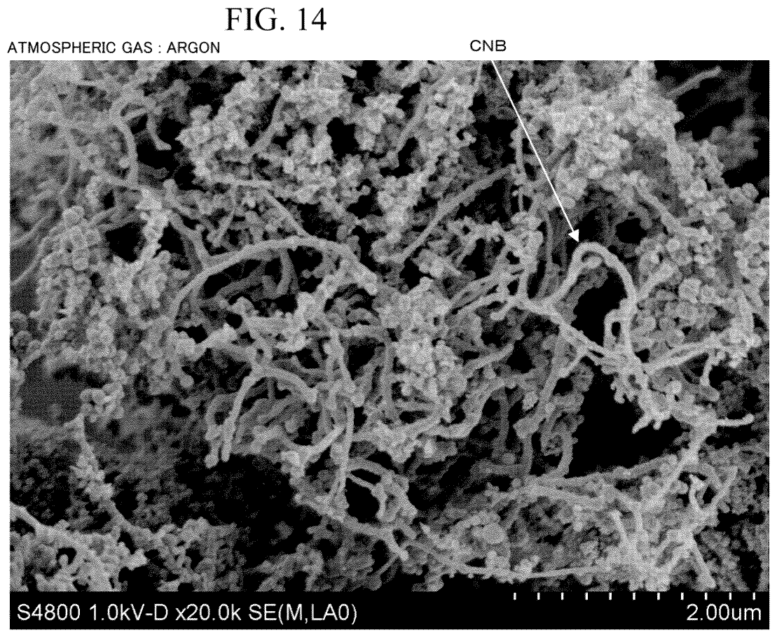

In Example 1, the incident angle, which was an angle θ between the laser L and the normal line N of the peripheral surface in the portion irradiated with the laser, was set to 60°. An experiment for generating CNB was performed by using helium, nitrogen, and argon as an inert gas in the chamber 14 and setting the other conditions in the same manner. An obtained sample was treated in the same manner as in Example 1, and CNB/CNHs obtained by evaporating ethanol was observed using a SEM. The results are shown in FIGS. 12 to 14. In each of the inert gases, many CNB and granular CNHs attached to the surface of the CNB were confirmed.

It was confirmed that, as the atomic weight of the inert gas increased, a CNB generation rate was improved in the SEM image.

Although some example embodiments of the present disclosure have been described above, these example embodiments are shown as examples and are not intended to limit the scope of the disclosure. These example embodiments can be implemented in various other forms, and various omissions, substitutions, and changes can be made without departing from the gist of the present disclosure. These example embodiments and their modifications are included within the scope and gist of the present disclosure, as well as within the scope of the present disclosure and its equivalents. The example embodiments can be combined with several other example embodiments as appropriate.

Some or all of the above-described example embodiments may be described as in the following supplementary notes, but are not limited to the following.

### (Supplementary Note 1)

A nanocarbon generation apparatus including:
a cylindrical target that contains carbon and a catalyst; and
a laser irradiator configured to irradiate a peripheral surface of the cylindrical target with a laser beam at an incident angle of 50° or more and 80° or less, the incident angle being an angle between the laser beam and a normal line of the peripheral surface in a portion irradiated with the laser beam.

### (Supplementary Note 2)

The nanocarbon generation apparatus according to supplementary note 1, wherein the incident angle is 60° or more and 70° or less.

### (Supplementary Note 3)

The nanocarbon generation apparatus according to supplementary note 1 or 2, wherein the catalyst contains one of a group consisting of Fe, Ni, and Co.

### (Supplementary Note 4)

The nanocarbon generation apparatus according to any one of supplementary notes 1 to 3, wherein a bulk density of the cylindrical target is 1.5 g/cm³ or less.

### (Supplementary Note 5)

The nanocarbon generation apparatus according to any one of supplementary notes 1 to 4, wherein an amount of the catalyst with respect to the cylindrical target is 0.5 at. % or more and 3 at. % or less.

### (Supplementary Note 6)

The nanocarbon generation apparatus according to any one of supplementary notes 1 to 5, wherein the laser irradiator is configured to irradiate the peripheral surface with the laser beam in a plane perpendicular to a cylindrical axis of the cylindrical target.

### (Supplementary Note 7)

The nanocarbon generation apparatus according to any one of supplementary notes 1 to 6, further including an adjuster configured to shift a cylindrical axis of the cylindrical target with respect to the laser beam.

### (Supplementary Note 8)

The nanocarbon generation apparatus according to any one of supplementary notes 1 to 7, wherein an atmospheric gas in the nanocarbon generation apparatus is an inert gas with an atomic weight equal to or more than an atomic weight of argon.

### (Supplementary Note 9)

A nanocarbon manufacturing method including:
disposing a laser irradiator configured to emit a laser beam and a cylindrical target containing carbon and a catalyst; and
irradiating a peripheral surface of the cylindrical target with the laser beam at an incident angle of 50° or more and 80° or less, the incident angle being an angle between the laser beam and a normal line of the peripheral surface in a portion irradiated with the laser beam.

### (Supplementary Note 10)

The nanocarbon manufacturing method according to supplementary note 9, further including collecting nanocarbon.

### (Supplementary Note 11)

The nanocarbon manufacturing method according to supplementary note 9 or 10, wherein the disposing of the laser irradiator and the cylindrical target includes shifting a cylindrical axis of the cylindrical target with respect to the laser beam.

What is claimed is:

1. A nanocarbon generation apparatus comprising:
a cylindrical target that contains carbon and a catalyst; and
a laser irradiator configured to irradiate a peripheral surface of the cylindrical target with a laser beam at an incident angle of 50° or more and 80° or less, the incident angle being an angle between the laser beam and a normal line of the peripheral surface in a portion irradiated with the laser beam.

2. The nanocarbon generation apparatus according to claim 1, wherein the incident angle is 60° or more and 70° or less.

3. The nanocarbon generation apparatus according to claim 1, wherein the catalyst contains one of a group consisting of Fe, Ni, and Co.

4. The nanocarbon generation apparatus according to claim 1, wherein a bulk density of the cylindrical target is 1.5 g/cm³ or less.

5. The nanocarbon generation apparatus according to claim 1, wherein an amount of the catalyst with respect to the cylindrical target is 0.5 at. % or more and 3 at. % or less.

6. The nanocarbon generation apparatus according to claim 1, wherein the laser irradiator is configured to irradiate the peripheral surface with the laser beam in a plane perpendicular to a cylindrical axis of the cylindrical target.

7. The nanocarbon generation apparatus according to claim 1, further comprising an adjuster configured to shift a cylindrical axis of the cylindrical target with respect to the laser beam.

8. The nanocarbon generation apparatus according to claim 1, wherein an atmospheric gas in the nanocarbon generation apparatus is an inert gas with an atomic weight equal to or more than an atomic weight of argon.

9. A nanocarbon manufacturing method comprising:
disposing a laser irradiator configured to emit a laser beam and a cylindrical target containing carbon and a catalyst; and
irradiating a peripheral surface of the cylindrical target with the laser beam at an incident angle of 50° or more and 80° or less, the incident angle being an angle between the laser beam and a normal line of the peripheral surface in a portion irradiated with the laser beam.

10. The nanocarbon manufacturing method according to claim 9, further comprising collecting nanocarbon.

11. The nanocarbon manufacturing method according to claim 9, wherein the disposing of the laser irradiator and the cylindrical target includes shifting a cylindrical axis of the cylindrical target with respect to the laser beam.
